(19) United States
(12) Patent Application Publication
(10) Pub. No.: US 2016/0221361 A1
(43) Pub. Date: Aug. 4, 2016

(54) DEVICE FOR PRINTING ROTATIONALLY ASYMMETRICAL CONTAINERS

(71) Applicant: TILL GMBH, Kelkheim (Taunus) (DE)

(72) Inventors: Volker TILL, Hofheim am Taunus (DE); Frank CHOLEWIK, Hattersheim (DE)

(73) Assignee: Till GmbH, Kelkheim (Taunus) (DE)

(21) Appl. No.: 15/021,723

(22) PCT Filed: Sep. 5, 2014
(86) PCT No.: PCT/EP2014/068979

§ 371 Date: Mar. 14, 2016

(30) Foreign Application Priority Data
Sep. 13, 2013 (DE) 10 2013 110 103.8

(51) Int. Cl. B41J 3/407

(52) U.S. Cl. CPC B41J 3/4073

(57) ABSTRACT

A device for printing rotationally asymmetrical containers includes at least one print head and a rotary table configured to rotationally drive at least one receptacle attached to the rotary table for a rotationally asymmetrical container to be printed about a first rotational axis. The receptacle is arranged eccentric to the first rotational axis of the rotary table and accommodates the container in such a way that an outermost section of a surface to be printed of the container accommodated in the receptacle is guided in a first circular path about the first rotational axis.

### CROSS-REFERENCE TO PRIOR APPLICATIONS

This application is a U.S. National Stage Application under 35 U.S.C. §371 of International Application No. PCT/EP2014/068979 filed on Sep. 5, 2014, and claims benefit to German Patent Application No. DE 10 2013 110 103.8 filed on Sep. 13, 2013. The International Application was published in German on Mar. 19, 2015 as WO 2015/036334 A1 under PCT Article 21(2).

### FIELD

The invention relates to a device for printing on non-rotationally symmetrical or rotationally asymmetrical containers, in particular, oval containers, preferably, by means of digital printing, said device comprising at least one print head and a rotary table for rotationally driving at least a receptacle for the containers to be printed around a first rotational axis, wherein said receptacle is connected to the rotary table. The containers may be, for example, bottles made of plastic and/or glass.

### BACKGROUND

The printing of containers by means of digital printing is generally known, wherein, in particular, printing processes such as the drop-on-demand method are used, in which an area on the surface of the container to be printed is guided past one or more print heads that are arranged around the container in a system, wherein the print heads spray the surface of the container with a printing medium from spray nozzles while the container rotates in front of the print heads. With increasing variability of the container's contours that can be configured not only rotationally symmetrically but also rotationally asymmetrically with respect to a vertical axis or a longitudinal axis of the container, the quality requirements of the printed image also increase, especially for chemical products, such as household cleaners, containers in various shapes that also need to meet high printing quality requirements are in demand.

The printing of rotationally symmetrical objects is relatively unproblematic. DE 10 2009 058 222 A1 discloses, for example, a system for printing of containers, in which a cylindrical container to be printed is placed on a rotary table, which is rotated by a servo motor about a rotational axis or the axis of symmetry of the container that is on the longitudinal axis of the container. Print heads, which are arranged around the container, spray the printing medium on it.

In digital printing with inkjet print heads, the drops of the printing medium ideally contact the surface to be printed at a 90° angle of incidence. While the distance between the object surface and the print head remains constant in a symmetrically rotating object, the distance between the object surface and the print head or the radius between the surface to be printed and the rotational axis continuously changes in a non-rotationally symmetrical object. In the case of non-rotationally symmetrical containers, for example, a shampoo bottle, the problem of constant change in the orientation of the printed surface facing the print head during rotation also occurs. In other words, a surface tangent that is applied to the outer surface of the container in the print area and faces the print head may change its position with respect to the print head, for example, drop down. In the case of oval-shaped containers, which have an oval cross-section along the direction of their vertical axis in the area to be printed, this means that the printing medium is sprayed on an inclined plane and consequently leads to smearing or dispersion, so that no circular printing point is produced.

Therefore, the printing of rotationally asymmetrical containers requires great technical effort to obtain a satisfactory print result. Besides the rotational axis of the container, a second servo axis is required, which produces the necessary spacing and the correct alignment between the surface to be printed and the print head, for example, by pivoting or displacing the print head itself. However, it must be taken into account that the relative speed between the area to be printed on the surface of the container and the print head, in the case of an object rotating asymmetrically about an rotational axis, changes as a function of the distance between the printing point on the surface of the container and its rotational axis. This leads to increased technical effort and requires complex control of the printing process to ensure that the relative speed between the print head and the printed surface remains constant.

### SUMMARY

In an embodiment, the present invention provides a device for printing rotationally asymmetrical containers including at least one print head and a rotary table configured to rotationally drive at least one receptacle attached to the rotary table for a rotationally asymmetrical container to be printed about a first rotational axis. The receptacle is arranged eccentric to the first rotational axis of the rotary table and accommodates the container in such a way that an outermost section of a surface to be printed of the container accommodated in the receptacle is guided in a first circular path about the first rotational axis.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a plan view of the inventive device according to the first embodiment of the invention;

FIG. 2 is a section view of the device in FIG. 1;

FIG. 3 is a section view of the device in accordance with the invention according to a second embodiment of the invention;

FIG. 4 is a plan view of the device according to a third embodiment of the invention; and

FIG. 5 depicts a fourth embodiment of the device according to the invention.

### DETAILED DESCRIPTION

In an embodiment, the invention provides a device, with which the printing of containers with a rotationally asymmetric surface is possible with high print quality and at high capacity utilization of the printing press.

In an embodiment, a receptacle is arranged eccentrically to the first rotational axis of the rotary table and takes up the container such that an outermost section of the surface to be printed of the container held in the receptacle is guided in a first circular path about the first rotational axis. In the process, the vertical axis or the longitudinal axis of the container held in the receptacle is offset parallel to the first rotational axis. In relation to the first rotational axis, the outermost section describes the point or a section in the print area that has the greatest distance from the first rotational axis.

Unlike systems in which the longitudinal axis of the container coincides with the common rotational axis of the rotary table and the receptacle, the invention offers the possibility of optimally printing non-rotationally symmetrical containers, in particular, containers that are longitudinally oval, oval-shaped or have an elliptical cross-section. An oval container or an oval bottle, the form primarily used for household chemicals or other chemical industry products, such as shampoo, generally has a more or less constant cross-section in the vertical direction in the print area. In a container having an elliptical cross-section, the cross-section has two opposing long elliptic arcs and two short elliptic arcs. The longitudinal axis of the container generally extends from the bottom of the container to the top. Ideally, the device comprises a drive mechanism such as a motor for rotationally driving the rotary table.

An embodiment of the invention is based on the idea of placing the container on a rotary table eccentrically so that the generally arc-shaped area to be printed resembles an arc around the central rotational axis in shape. It is proposed that the radius of curvature of the circular path to the radius of curvature of the print area is approximated as, for instance, a long elliptic arc in the print area moves along a circular path when the container rotates about its longitudinal axis. This can be achieved by the eccentric arrangement of the container and the rotational axis. In the case of a container having an elliptical cross-section, for a satisfactory print image, a close osculation can be adjusted between the elliptic arc of the print area and the circular path such that the small distances between the print area and the circular path are negligible.

To make the printing process more efficient, according to a further embodiment of the invention, multiple print heads are arranged around the first rotational axis so that they have an equal distance to a circumscribed circle that is defined by the first circular path and surrounds the surface of the rotationally asymmetric container to be printed. Substantially more print heads can be arranged on the rotary table as the circumscribed circle is larger than in a rotationally symmetrical container, which is rotated about its longitudinal axis, due to the eccentric arrangement of the receptacles. For example, all of the inks required for printing can be arranged around the rotary table.

It has been found to be particularly advantageous if the distance between one or more print head(s) and the circular path is from 5 mm to 20 mm, preferably from 5 to 10 mm. This allows a particularly consistent print image to be achieved. For print images that require a fine and sharp print image, such as text print, it is advantageous if the distance is about 5 mm to 8 mm.

The container should be fixed on the rotating rotary table during printing, so as to prevent any deterioration of the print image. Thus, the print area encircles the first rotational axis at a constant first circular path and remains pointed radially outwards. Preferably, the receptacle is adapted to the outer contour of the container, in particular, in the holding or mounting section, in which the container is inserted into the receptacle and held. According to an embodiment of the invention, the receptacles are adapted to the outer contour of the container such that the container form-fits in the receptacle and is centered so that it does not twist during printing. The receptacle may be configured as a format set, which is integrally configured or replaceably mounted on the rotary table. This allows the economical use of a printing apparatus for differently sized containers, bottles, cans or the like. The so-called format sets are individually adapted to a wide variety of container shapes and act as adapters between the container and the printing apparatus. Depending on the shape of the container, a suitably designed format set is used to transport, fix or align the container within the printing apparatus for printing. Ideally, the rotary table can be turned about the first rotational axis by means of a suitable motor, for example, a servo motor.

According to another embodiment of the invention, the one or more print head(s) can be adjusted perpendicularly to the first rotational axis. Thus, the one or more print head(s) can be moved radially inward and/or outward and the position of the print head can be adapted to various diameters of the circumscribed circle. Thus, different container sizes can be printed in the same printing apparatus. The one or more print head(s) can be adjusted to the first rotational axis, so as to allow printing on a rotationally symmetrical container. Another embodiment of the invention provides that the receptacles are adjustable on the rotary table in the radial direction. In an embodiment of the invention, it is also provided that the print heads are adjustable parallel to the first rotational axis.

According to another embodiment of the invention, the print heads are arranged in multiple superposed horizontal planes. It turns out to be particularly advantageous if the print heads are not only positioned circularly on a plane around the circumscribed circle, but are also distributed in the vertical direction. The print heads may be arranged such that a print area is simultaneously printed by several print heads. This allows the production of the print images, whose width and/or height exceed the print width and/or print height of a single print head. The print heads may be distributed circumferentially around the circumscribed circle and arranged distributed in several parallel, superposed planes, thus achieving an economical printing process. Several print heads can be placed on a common plane around the rotary table offset from each other. The distributed arrangement of the print heads offers a more efficient printing process by providing the option of leaving the print areas, for example, to be closely superposed in the vertical direction, thus allowing the production of a uniform print image, which is composed of several portions, each of which is printed by a single print head. Similarly, it is possible that the print areas for each of the print heads overlap at least partially. The print heads, for example, have about 1,000 print nozzles and can cover a print area in the vertical direction of about 70 mm each. However, in practice, the individual print head, due to the fasteners required, often have a height of 130 mm. This would result in a non-printed gap-like section in print heads that are exclusively arranged one above the other. On the other hand, if the print heads are distributed in several horizontal planes and arranged offset to one another in the peripheral direction of the rotary table, these gaps can be closed. A further advantage in particular is that an annular offset arrangement of the print heads ensures that the print medium is applied at an optimum angle to the container, while in a large and very wide print head, the problem occurs that the print medium ejected from an external print nozzle is ejected at an angle to the container.

According to a further embodiment of the invention, the rotary table is adjustable along the first rotational axis. Thus, the rotary table can be navigated, with or without a container, out of the area of the print heads by raising or lowering, such as for feeding in and removing the container or for rotating the container, so that, in addition to a first outer surface, a second surface lying opposite the first surface can also be printed. This is especially advantageous, particularly where there are tight spaces in the print area.

According to a further embodiment of the invention, multiple receptacles, in particular, uniformly distributed about the first rotational axis, are provided on the rotary table. This increases the flow rate of the printing apparatus. The receptacles are preferably arranged on the rotary table such that the containers arranged therein have a uniform first circular path and a common circumscribed circle.

In order to print on both sides of a rotationally asymmetric container, it is proposed that the receptacle is capable of being rotated through a second rotational axis and that the second rotational axis is offset parallel to the first rotational axis. Thus, a container is not only guided about the first rotational axis past the print heads, but is also rotated along its longitudinal axis, such that a radially outward facing outer surface, e.g. the first elliptic arc, turns inward about the second rotational axis by 180° and is aligned to the first rotational axis, whereby the second surface to be printed lying opposite the first surface (for example, the second elliptic arc) is pivoted outwards. This can then be guided about the first rotational axis, past the rotation of the rotary table to the print heads. Ideally, each receptacle of the rotary table is equipped with a rotating device, with the help of which the containers can preferably be simultaneously rotated about their respective longitudinal axes. Depending on the container shape, other rotation angles, e.g., a rotation angle of 120° for triangular containers, are also possible.

According to a further embodiment, the receptacle can be rotated on a gear arranged on a rotary table. In a further development of this invention, the gear is a planetary gear with a first transmission element that can rotate about the first rotational axis, at least one second transmission element connected with the first transmission element, a second transmission element with a rotatory connection with the receptacle, and a carrier element rotatable about the first rotational axis, on which the second transmission element is rotatably mounted. By mounting the second transmission element on the carrier element, the second transmission element can rotate about the second rotational axis, but is otherwise stationary on the carrier element. In this way, a rotary drive device and setting device is developed according to the type of planetary gear, whereby the central first transmission element, the first sun gear, the second transmission element, the planetary gear and the carrier element form the planetary carrier.

In order to achieve maximum variability in the control and positioning of the receptacles, according to another embodiment of the invention, a method of braking or fixing the carrier element about the first rotational axis is provided. Clutches, such as are known from transmission manufacturing e.g. multi-plate clutches or other locking and/or brake mechanisms, that are arranged in such a way that the carrier element can be prevented from moving about the first rotational axis, and can thus stay fixed, are one option. By fixing the carrier element, the carrier element can be blocked from a rotational movement about the first rotational axis. The second transmission element is also prevented from moving about the first rotational axis by being mounted on the carrier element, but can continue to rotate about the second rotational axis. By mounting the carrier element, a container located in the receptacle can rotate about its longitudinal axis. Preferably, the first transmission element and the second transmission element are configured like gearwheels and roll off one another.

According to another embodiment of the invention, additional or alternate methods are provided for the relative braking or fixing, preferably non-rotatable clutches of the first transmission element and carrier element. Thus, a block rotation is used, wherein the second transmission element can be blocked from rotating about the second rotational axis. The first transmission element, the second transmission element and the carrier element collectively turn about the first rotational axis when the first transmission element is driven rotationally about the first rotational axis. The three transmission elements thus form a unitary rotary table on which the receptacle or a container located in the receptacle is guided around, eccentrically offset to the first rotational axis. The center of rotation of the container is thus the first rotational axis.

In addition to at least one print head, it is also possible to provide suitable energy sources, such as a UV lamp, to dry/cure or to further treat the print medium radiated onto the container. It has proven to be advantageous if the energy source is adjustable perpendicularly and/or parallel to the first rotational axis so that its position can be adapted to various diameters of the circumscribed circle.

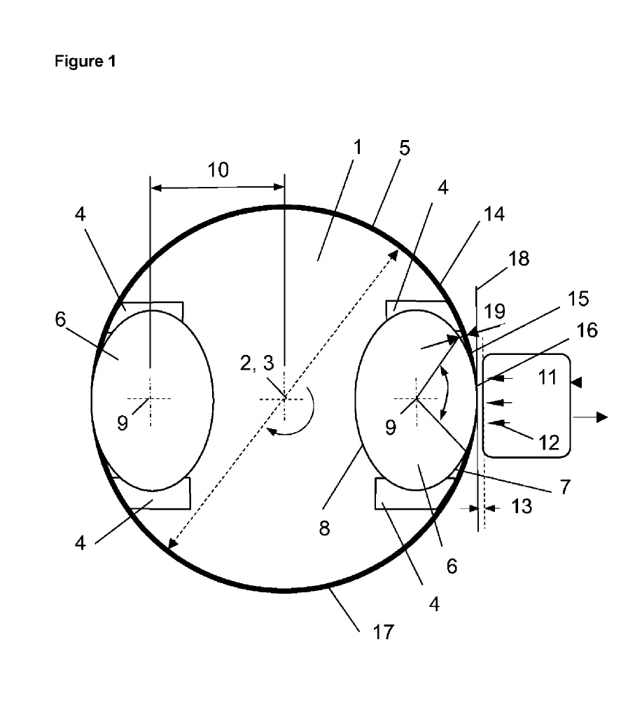

In FIG. 1, a circular rotary table 1 is shown as part of a printing apparatus according to an embodiment of the invention, which is rotatable about a first central rotational axis 3 that passes through its center 2. Two receptacles 4 for receiving containers, such as plastic bottles, each at the periphery 5 of the rotary table 1, are attached to this and form a receptacle for the containers 6, which are inserted in the receptacles 4. The receptacles 4 are configured as format sets, and are adapted to the outer contour of the respective container 6 to be printed, such that the container 6 is held in the receptacle 4. The shape and size of the receptacle 4 are accordingly adapted to the section of the container 6 to be printed, which is inserted into the receptacles 4. In the drawing, two receptacles 4 are provided by way of example. It is understood, however, that only one receptacle 4 or preferably multiple receptacles 4 distributed along the entire periphery of the rotary table 1 can be provided.

The containers 6, in plan view, always have the shape of an ellipse in the print area and are arranged in such a way that an outer elliptic arc 7 is located at the periphery 5 of the rotary table 1. An inner elliptic arc 8 is opposite the outer elliptic arc 7 and is aligned with the center 2. The receptacles 4 are each arranged eccentrically to the rotational axis 3 of the rotary table 1, wherein the ellipse center 9 of the receptacle 4 is at a distance 10 and is radially offset from the rotational axis 3 and the center 2. Laterally next to the rotary table 1 is arranged a print head 11 having multiple nozzles 12, which are essentially aligned to the center 2 of the rotary table 1 and lie at a distance 13 from the container 6. In practice, multiple print heads 11 are arranged, distributed over the periphery of the rotary table 1, in order to apply different colors to the container 6.

When the rotary table 1 rotates about the first rotational axis 3, a radially outermost portion of the container 6 moves on a circular path 14 about the rotational axis 3 and thereby defines a circumscribed circle 17 around the surface 15 of the container 6 to be printed. In the plan view of FIG. 1, the circumscribed circle 17 is aligned with the periphery 5 of the rotary table 1. The print area 15 on the container 6 provided on the outer elliptic arc 7 is characterized by a portion (angle cuts) of the outer elliptic arc 7, whereby the outermost section 16 to be printed has the greatest distance from the rotational axis 3 and defines the radius of the circumscribed circle 17. The outer contour of the container 6 disconnects from the elliptic arc 17, starting from the outermost section 16 to be printed, along the outer elliptic arc 7. In the illustrated projection level, there is a point contact between the outermost section 16 to be printed and the elliptic arc 17, while the distance between the circumscribed circle 17 and the print area 15 and the lateral limits of the print area 15 gradually decreases. Due to the eccentricity and the best possible adaptation of the circumscribed circle 17 to the elliptic radius, there is a close osculation between the circumscribed circle 17 and the elliptic arc 7.

If the rotary table 1 rotates about the rotational axis 3, the containers 6 also rotate about the central rotational axis 3. The containers 6 are guided past the print head 11 and are thus printed with the printing medium from the nozzle 12. The print medium runs perpendicular to the tangent 18 to the outermost section 16 to be printed, the circular path 14 and the circumscribed circle 17 and thus perpendicular to the section 16, while the remaining portion of the print area 15 is illuminated slightly diagonally. Due to the close osculation between the circumscribed circle 17 and the elliptic arc 7 to be printed, the maximum distance between the print area 15 and the circumscribed circle 17 is minimal, which ensures satisfactory print quality.

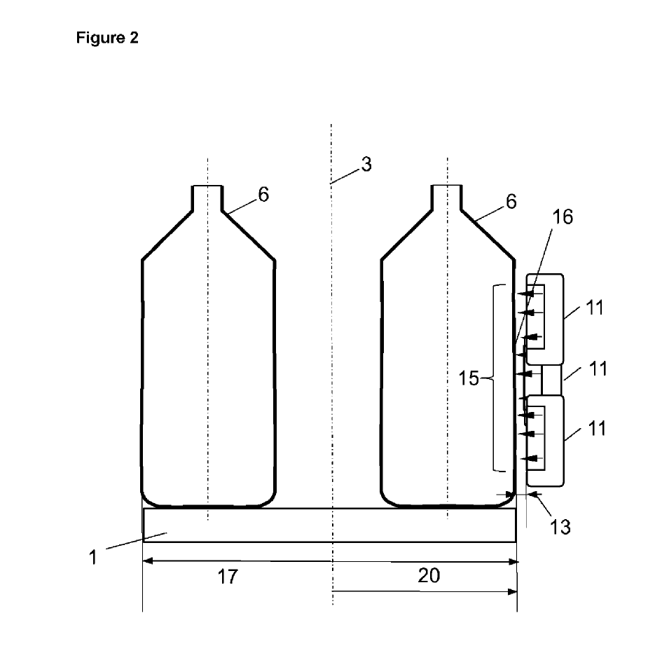

FIG. 2 is a lateral section view of the rotary table 1 in accordance with FIG. 1. The containers 6 are all arranged at the outer edge of the rotary table 1 such that their outermost section 16 to be printed is aligned to the periphery 5 of the rotary table 1 in a direction parallel to the first rotational axis 3. Three print heads 11 are distributed in three superposed planes in a perpendicular direction and arranged in a viewing direction partially displaced to each other such that they cover the entire print area 15. Each of the three print heads 11 is arranged at an equal distance 13 from the circumscribed circle 17. The top and bottom of the print head are arranged vertically above one another while the middle print head is offset against the topmost and lowest print head in a peripheral direction and yet maintains the same distance 13 to the circumscribed circle 17 as the other two print heads. As can be clearly seen, the yet to be printed outermost section 16 of the container 6 forms the radius 20 of the first circular path 14 on the rotary table 3 and thus also the radius of the circumscribed circle 17. It is clear that, instead of the three print heads offset in a vertical direction as shown here, more print heads may be provided to cover a wider print area.

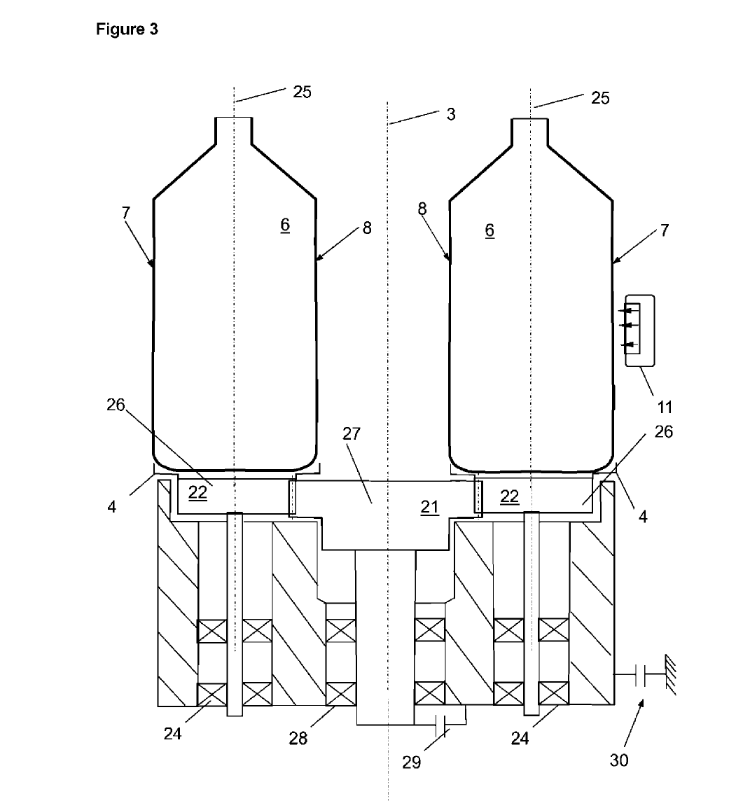

FIG. 3, comprises a rotary table 1, a first transmission element 21, two second transmission elements 22 and a carrier element 23, which are coupled to one another in the manner of a planetary gear. The first transmission element 21 forms the sun gear while the second transmission elements 22, the planetary wheels and the carrier element 23 constitute the planetary carrier. The second transmission elements 22 are mounted on the carrier element 23 by means of a bearing 24, mounted rotatably about the second rotational axis 25. The second rotational axis 25 is parallel to the first rotational axis 3. The second transmission elements 21, 22 each have an upper gear 26, which meshes in a direction perpendicular to the first rotational axis 3 on the outside with a gear 27 of the first transmission element 21. The gears 26 are permanently connected to the receptacle 4 for the container 6 such that during a rotation of the second transmission element 22 about the second rotational axis 25, the corresponding receptacle 4 and the container 6 similarly rotate about the second rotational axis 25.

The first transmission element 21 is rotatably mounted on the carrier element 23 via a bearing 28, such that the first transmission element 21 can rotate about the first rotational axis 3 relative to the carrier element 23.

A schematically represented first clutch 29 is used for braking or inhibiting a relative movement or rotation between the carrier element 23 and the first transmission element 21. By means of a second clutch 30, which can be switched if required, the supporting element 23 can be fixed so that a rotation about rotational axis 3 is prevented. By means of the clutches 29, 30, the rotary table 1 can be operated and controlled in different operating modes. The first transmission element 21 is connected to a rotary drive motor which can rotationally drive the first transmission element 21 about the first rotational axis 3. When the first transmission element 21 and the carrier element 23 are linked together via the first clutch 29, the containers 6 are moved about the rotational axis 3, whereby the outer elliptic arc 7 continues to be directed radially outward. On the other hand, if the first clutch 29 is released and the second clutch 30 is locked, such that the carrier element 23 is prevented from rotating about the rotational axis 3, the second transmission element 22 will be rotated about the second rotational axis 25 as a result of the tooth contact between the sun gear 27 and the planetary gear 26, whereby the second rotational axis 25 runs here through the elliptic center of the container 6. Due to the rotation of the second transmission element 22 about the second rotational axis 25, the outer elliptic arc 7 is pivoted toward the first rotational axis 3 to the inside, while the inner elliptic arc 8 is pivoted outward, so that subsequently, when the first clutch 29 is locked and the second clutch 30 is released again, each of the inner elliptic arcs 8 of the container 6 can be guided past the print head 10 and printed.

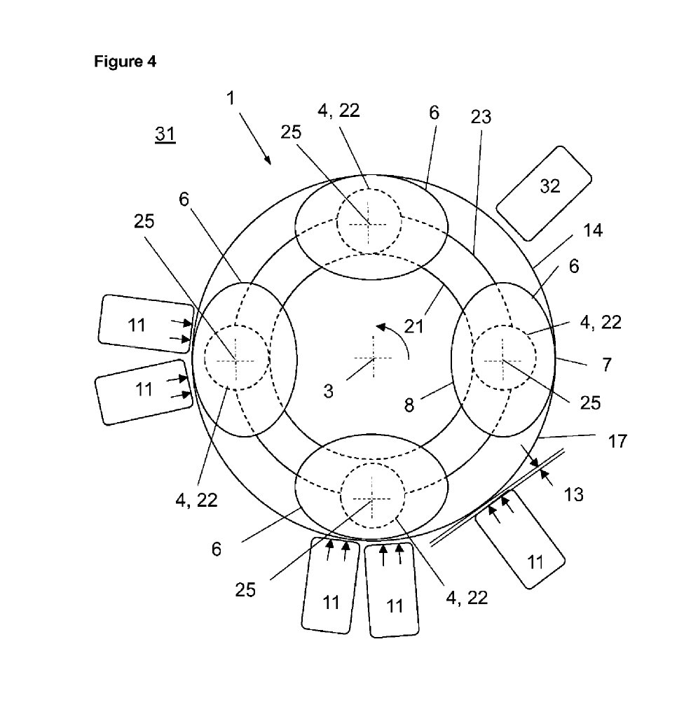

FIG. 4 shows components of an attachment 31 for printing non-rotationally symmetrical containers 6 with the printing apparatus according to an embodiment of the invention. The rotary table 1 here comprises four receptacles 4 for containers 6, arranged centrally about the first rotational axis 3, each of which is mounted on planetary gears (second transmission elements) 22. The planetary gears 22 are each connected to the carrier element 23 and are mounted on it, rotatable about the second rotational axis 25. The planetary gears 26 interlock respectively with the sun gear (first transmission element) 21. The rotary table 1 is movable vertically upward and downward along the first rotational axis 3, such that the rotary table 1 can be operated from the area of the print heads 11.

The outermost areas to be printed for each of the containers 6 shown in FIG. 4 are located on the collective circumscribed circle 17. The print heads 11 have all been arranged at an equal distance from the circumscribed circle 17. The distance 13 is chosen such that a collision with the containers is avoided. At the same time, however, they are positioned close to the circumscribed circle 17 so that, even with increasing distance between the container outer wall and the print head 11, a high-quality pint image is generated in the print area.

In a first step, the containers 6 are inserted into the receptacles 4 and the rotary table 1 is driven in the print area by means of a lifting device, whereby the containers 6 are positioned between the print heads. Subsequently, the rotary table 1 is rotated about the first rotational axis 3, as indicated by the arrow. The carrier element 23 is fixed to the sun gear 21, such that the carrier element 23, the sun gear 21 and the planetary gears 22 rotate about the first rotational axis 3 as a block, whereupon each of the outer elliptic arcs 7 of the container 6 is directed through the print heads 11 and printed. After each container 6 has been printed by the print heads 11, the print applied is cured by means of a UV lamp 32. After the outer side 7 of all the containers 6 has been printed, the rotary table 1 is moved from the print area using a lifting device and each receptacle 4 is pivoted about the second rotational axis 25 with the help of a gear, as has been described in reference to FIG. 3.

Since the container 6 may protrude over the edge of the rotary table 1 when the receptacles 4 swivel, due to the elliptic shapes, and collide with the print heads 11, the application is performed outside the print area. After the receptacle 4 has been applied, such that the inner side 8 of the container is turned radially outward, the rotary table 1 is again moved in the print area and the rotary table 1 rotates about the first rotational axis 3 as a block, such that the inner side 8 of the container can now be printed with the print heads 11.

After the printing process, the rotary table 1 is moved back to a position from the print area by raising or lowering, where the container that is now printed on both sides is replaced by unprinted containers.

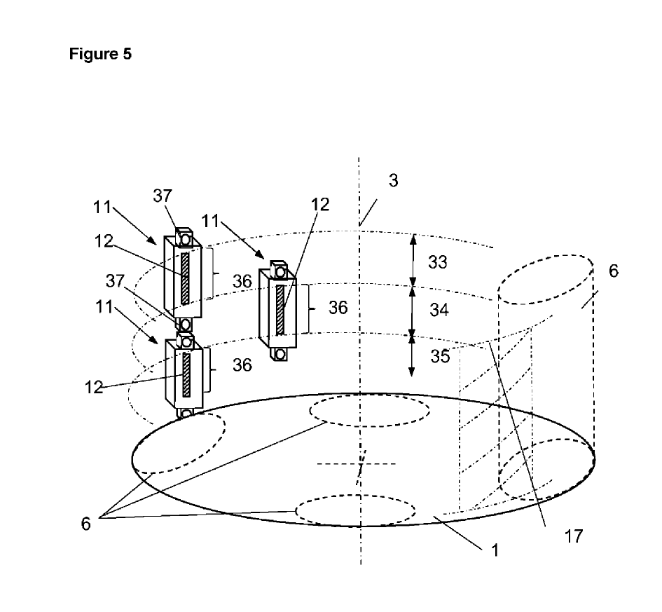

FIG. 5 is a schematic view of a part of a further printing device according to an embodiment of the invention, with multiple print heads 11 that are responsible for various elements of the print image, arranged around the rotary table 1. Identical oval containers 6 are placed on the rotary table 1 and are indicated with dashed lines for the purpose of illustration, wherein the corresponding receptacles are not displayed, but are present. The print heads 11 are positioned in multiple parallel levels 33, 34 and 35 situated horizontally one above the other, and are annularly distributed around the rotary table 1. The horizontal levels 33, 34, 35 also define three print levels. Each of the print heads 11 points in a horizontal direction at the same distance from the circumscribed circle 17 of the surface to be printed. The nozzles 12 of the print heads 11 are created in such a way that they can only cover a certain print area in the vertical direction, here, by way of example, a height of 70 mm in the vertical direction. On the other hand, the actual print head is much larger and extends, for example, over a height of 130 mm. This inevitably leads to a gap in the print image in the middle level 34 in both the print heads shown on the left side and located one above the other. In order to close this, all the nozzles 12 of the three print heads 11 are arranged in such a way as to cover an area 36 in the vertical direction, corresponding to the distance between the borders of two adjacent levels. Here, a print area is directly adjacent to the adjoining print area. Consequently, the central nozzle in the vertical direction on the right side covers the print area in the middle level 34. The nozzles 12 of the three print heads 11 are thus distributed in the print areas and levels 33, 34, 35 in such a way that, during printing, a uniform print image is created, especially in the vertical direction, wherein each of the print heads 11 prints a portion of the print image. In other words, the three print heads 11 are combined to make a large print head, the print area of which would extend across the three levels 33, 34, 35. The advantage of this, in particular, is that the annular arrangement of the print heads ensures that the print medium is applied at an optimum angle to the container, while, with a large and very wide print head, the problem occurs that the print medium ejected from the outer print nozzles can be applied obliquely to the print area. By distributing the print heads 11 in multiple layers 33, 34 and 35, a print image can be generated such that it is higher and, in a corresponding close arrangement of the print heads, greater in width than the single print head. The circumscribed circle 17 is illustrated in FIG. 4 by a part of the circumscribed circle subsegment that extends vertically in order to depict the size of the print area. As a matter of course, the print heads may also be arranged such that they overlap in the vertical direction in some areas. By the combined use of individual print heads, large print areas on large containers can also be printed quickly and efficiently.

Each of the print heads 11 has fasteners 37 at its upper and lower end, by means of which the print head can be secured to the printing apparatus. Suitable fastening options are, for example, screws, clamps, catches or other detachable and permanent connections.

Each of the print heads 11 is connected to an adjuster, with which each print head 11 can be moved perpendicularly to the first rotational axis 3.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 Rotary table
2 Midpoint/center
3 First rotational axis
4 Receptacles
5 Periphery
6 Container
7 Outer elliptic arc/outer side
8 Inner elliptic arc/inner side
9 Elliptical center
10 Clearance
11 Print head
12 Nozzles
13 Clearance
14 First circular path
15 Print area on the container
16 Outermost section to be printed
17 Circumscribed circle
18 Surface tangent
19 Maximum clearance
20 Radius
21 First transmission element/sun gear
22 Second transmission element/planetary gear
23 Carrier element/planetary carrier
24 Mounting
25 Second rotational axis
26 Gear
27 Gear
28 Mounting
29 First clutch
30 Second clutch
31 Attachment
32 UV lamp
33 Level 1/print area 1
34 Level 2/print area 2
35 Level 3/print area 3
36 Print area of the print nozzles
37 Fasteners

1-11. (canceled)

12: A device for printing rotationally asymmetrical containers, comprising:
at least one print head; and
a rotary table configured to rotationally drive at least one receptacle attached to the rotary table for a rotationally asymmetrical container to be printed about a first rotational axis, the receptacle being arranged eccentric to the first rotational axis of the rotary table and accommodating the container in such a way that an outermost section of a surface to be printed of the container accommodated in the receptacle is guided in a first circular path about the first rotational axis.

13: The device according to claim 12, wherein multiple print heads are arranged about the first rotational axis and are configured to maintain an even distance from a circumscribed circle defined by the first circular path around the surface to be printed of the container.

14: The device according to claim 12, wherein a clearance between the at least one print head and the circular path is from 5 mm to 20 mm.

15: The device according to claim 12, wherein the at least one print head is adjustable perpendicularly to the first rotational axis.

16: The device according to claim 13, wherein the print heads are arranged in a plurality of superposed horizontal planes.

17: The device according to claim 12, wherein the rotary table is adjustable along the first rotational axis.

18: The device according to claim 12, wherein a plurality of receptacles are provided on the rotary table, distributed about the first rotational axis.

19: The device according to claim 12, wherein the receptacle is rotatable about a second rotational axis, and wherein the second rotational axis runs parallel to the first rotational axis.

20: The device according to claim 19, wherein the receptacle is rotatable by means of a gear arranged on the rotary table.

21: The device according to claim 20, wherein the gear is a planetary gear having a first transmission element, rotatable about the first rotational axis, at least one second transmission element, meshed with the first transmission element, which is rotationally connected to the receptacle, and a supporting element, rotatable about the first rotational axis, on which the second transmission element is rotatably mounted.

22: The device according to claim 21, wherein the device is configured to at least one of fix the carrier element about the first rotational axis or brake or fix the carrier element relative to the first transmission element.

23: The device according to claim 12, wherein the device is configured for digital printing.
